(19) United States
(12) Patent Application Publication
(10) Pub. No.: US 2020/0188798 A1
(43) Pub. Date: Jun. 18, 2020

(54) Multi-Player Crosswords Game

(71) Applicant: Mark H. Small, Hatboro, PA (US)

(72) Inventor: Mark H. Small, Hatboro, PA (US)

(73) Assignee: Small Games Co., Hatboro, PA (US)

(21) Appl. No.: 16/798,072

(22) Filed: Feb. 21, 2020

Related U.S. Application Data
(63) Continuation of application No. 14/047,370, filed on Oct. 7, 2013, now abandoned.
(60) Provisional application No. 61/714,311, filed on Oct. 16, 2012.

(51) Int. Cl. A63F 13/80; A63F 9/00; A63F 3/04; A63F 13/335

(52) U.S. Cl. CPC A63F 13/80; A63F 9/0098; A63F 2003/0428; A63F 3/0423; A63F 13/335; A63F 3/0421

(57) ABSTRACT

A timed word game played on a game board. Words are formed from a predetermined set of alphabet letter tiles, including wild tiles exchangeable for alphabet letters. The exact same set of tiles (level playing field) is provided to each player playing the DAILY CHALLENGE. Thus, the DAILY CHALLENGE competition is based solely on skill. Each tile has a value of “1”, “2” or “3”, indicated by color. Words may stand alone or be intersecting. A total score is determined from word cumulative tile value with a deduction for misspelled words. Higher point words receive bonus points. The tile set may have multiple tiles of the same letter, with the same or different values. A total score is displayed at games end, the words made and respective scores may be viewed and/or printed. Top scores for each day's DAILY CHALLENGE are published.

### RELATED APPLICATIONS

This application claims priority to U.S. Provisional Application No. 61/714,311 filed Oct. 16, 2012, and incorporates that application by reference as if recited herein in full.

### BACKGROUND OF THE INVENTION

The present invention is directed to a crossword-type game played with letters to make words on a grid, where certain grid “blocks” are worth certain points or certain letters in a word “played” are worth certain points. Thus a word “played” accounts for a certain amount of points to the player. The words can intersect at certain “common letters” in the intersecting words to provide a cumulative score for the intersection or overlapping words.

Crossword games have in the past have generally taken one of two general configurations and playing rules. The first is a crossword puzzle most often printed in newspapers and magazines. This game is played on a grid with white and shaded (blackened) squares. This grid can be selected to be of any of a certain number of lines and columns of blocks, with certain of the blackened blocks as non-playable blocks. Typically, a grid for a crossword puzzle grid is square, being in the size of 13-by-13 (13×13), or 15-by-15 (15×15, 17-by-17 (17×17), 19-by-19 (19×19), 21-by-21 (21×21), or 23-by-23 (23×23).

In such crossword games, every player is going for the same exact pre-determined outcome. This outcome is a function of solving the puzzle with the respectively provided clues.

The number of blackened blocks, and the shapes formed by a series of interconnected blackened blocks contributes to a scoring of the puzzle being “easy”, “medium”, or “hard” to solve. With crossword puzzles, the game maker supplies a clue for the identification of each word to be entered on the grid, and correlates that clue with an identity supplied for the starting block for the word. A game is scored by the number of correct words a player “gets” (solves) solved. Such crossword puzzle games can be played with a pencil, or pen, or played electronically, depending upon the medium by which the crossword puzzle is presented.

The second configuration is a SCRABBLE game, which can be played on a paper or cardboard game board, or electronically on an electronic game board. SCRABBLE is a word game in which two to four players score points by forming words with individual letter tiles on the game board. The letter tiles each carry a point value which are assigned relative to the frequency of use of the letter in the English language. The points awarded to a player for forming a word are the cumulative total of the value of the tiles used to form a word.

Typically, a SCRABBLE game board is a 15-by-15 grid of blocks. Certain blocks on a game board, generally arranged in a geometric fashion are designated as multipliers. These multiplier blocks, either multiply the value of the letter tile placed on them, or multiply the cumulative value of the tiles forming a word overlaying of a multiplier tile.

With SCRABBLE, the words are formed across and down in crossword fashion. A word can be formed by intersecting (overlaying) an existing word with that word, by utilizing a letter in common to the two words. Points are awarded a player by adding up the cumulative value of the letter tiles used to make a word, and where formed by intersecting words by adding up the cumulative value of the letter tiles of intersecting words including the multiplier blocks.

The letter tiles a player has to work with are a product of the player's luck of the draw for each game. Repeat play with identical tiles is essentially nonexistent.

Where an electronic environment or medium is used to play the puzzle or game, the scoring of each “play”, the cumulative totals are automatically calculated, recorded and displayed. With manually played puzzles or games, this is accomplished manually.

With crossword puzzles each player plays with the same grid, the same shaded block pattern, and the same set of clues. Thus, the performance of each player can be compared with the performance of other players for a specific puzzle for a specific outcome. However, playing a crossword puzzle game requires a player to have a diverse knowledge of various subjects and facts to solve the clues in order to enter the correct word in the correct blocks. Moreover, a player must remember a word suggested by each clue to solve the puzzle. This becomes very frustrating to many players. It also can become very time consuming.

SCRABBLE can be played much more quickly as each player can make any word out of the tiles he/she has before him/her. No clues need be solved. A player need only form words officially resident in a dictionary. However, in playing SCRABBLE each player draws tiles from a pool and thereby each player plays with a different set of letters. As letters are used, additional letters are drawn from the pool. This means, each player's performance and score is to a lesser or greater degree dependent upon the luck of the draw. This can also become frustrating and dissatisfying.

With SCRABBLE, each game is a different game drawing from a combination and permutation of letter tiles providing the opportunity for a player to build an infinite combination words throughout the game as a function of the unique set of tiles each player draws.

What is desired is a board game style electronic or manually played game, played on a grid-style board, of individual blocks, with or without shaded (blackened) blocks, and without multiplier blocks.

What is further desired is that the object of the game is to form words on the game board, from letter tiles having individual values, where the value of each word is the cumulative total of the tile values.

What is also desired is that cross words may be formed on the game board where the cumulative score of a play is the cumulative value of both words.

What is additionally desired is that each played word be automatically evaluated against a dictionary database, where a deduction is assigned for a misspelled word.

What is even further desired is that the total score of each player be calculated and displayed at the end of each game.

What is also further desired is to award bonus points for forming words with scores over a given threshold score.

What is also additionally desired is to record game results for an identified player and to publish his/her game results to that player and to a designated social database elected by the player.

What is also additionally further desired is that for each day, the exact same set of selected tiles is provided to every player who plays the game that day, wherein a 24 hour day may alternatively be adjusted to any number of hours, and where a nominal time limit is assigned to play a game, where the time limit clock can be adjusted and/or eliminated.

What also, moreover desired is a method of generating alphabet tiles, scoring and publishing game results each day.

What is summarily desired is:

1. a game that is started at the convenience of the player and can be played anytime with repeat plays optional so as to cater to a massive target audience;

2. a game that is easy to learn and play, fast-paced and of universal appeal so as to attract a wide audience;

3. a game that is easy enough to play and both challenging and fun so as to appeal to both adults and children; and

4. a game that provides the educational benefits of improving one's spelling, vocabulary and critical thinking.

### SUMMARY OF THE INVENTION

These objectives are realized in an Internet-based, on-line, word game for building words on an electronic grid, within a fixed period of game time play. Alternately, the game can be played on a physical game board. The game can also be based in a LAN system, arcade-type or casino-type machine environment. The game can be played with one, two, or more players competing against themselves or against all of the other Internet players.

The game is played on an electronic grid of 49 squares, i.e., seven rows and seven columns, or in the manual version, on a physical game board with the same number of squares. A fast-paced, five-minute time limit controls the length of time for each game played.

Unlike a SCRABBLE board where certain grid positions are assigned a bonus value, the grid of the game board of the present invention does not assign a bonus value to any square. The game assigns a value to letter tiles by color coding. Letter values are also indicated by numbers from “1” through “3” inclusive, adjacent to each tile. Varying bonus points can be achieved by making individual word scores of 10 or more.

Every day the game “DAILY CHALLENGE™” competition presents a new set of 21 letter tiles and three wild star tiles, having a value of one of “1”, “2”, or “3” points, respectively. The wild star tiles, which can be converted into any letter in the alphabet, are given the same respective values. Each DAILY CHALLENGE game provides a player the opportunity to build an infinite possible combination of words from the exact same set of tiles. It may be virtually impossible that any two players may form an identical combination words and crossed words. However, one or more players may achieve the top score by forming a different combination of words and crossed words.

An administrator program allows for the selection of the letter tiles for the DAILY CHALLENGE. Duplicate copies of letters may be present. Each letter's assigned color indicates value with yellow, red and blue indicating a value of “1”, “2”, and “3”, respectively. Wild star tiles, which also follow the same color scheme, can be exchanged for any letter of the alphabet.

Letter tiles may be used at anytime and anywhere on the grid and can be moved around as often as a player elects. Wild star tiles may also be used at anytime and anywhere on the grid. However, once a letter is selected for a wild star tile, the selected letter cannot be changed nor moved from its selected grid position.

When playing the DAILY CHALLENGE, each Internet player, including each FACEBOOK player, on that day, is given exactly the same tiles to play. Thus, a level playing field is presented to each player for each day. A player's total score is based solely on skill and not on luck of the draw. The final score is then compared to the five highest scores of that day for the DAILY CHALLENGE. If a score is within the top five scores for the day, it is published as a number value. In addition the previous day's top score can be viewed, with the word list built and resultant scores for each word and crossword grid. The top five scores can change as a day continues based on a new player's new play, or on an existing player replaying the DAILY CHALLENGE for a higher score.

The DAILY CHALLENGE allows a player to compete against the entire population on the Internet who have and/or will play the game that day, for a top five score, including all FACEBOOK players. Players may also form their own competitions in which they email, text or telephone each other with their respective scores.

Each player must sign in before game play can begin. FACEBOOK players can enter the game either through an Internet address or though an individual FACEBOOK account. FACEBOOK players are automatically signed into the game when they enter the game through their FACEBOOK account. When a game is completed, scores may be posted to a respective FACEBOOK wall, and/or as a challenge to a player's FACEBOOK friend(s) to beat a score.

A player may play the DAILY CHALLENGE as may times as he/she likes, in order to try to increase his/her score. After each game, the player may download and print his/her game performance.

Words must be two or more letters long, and can be made both horizontally (left to right) and vertically (top to bottom), either crossword style or individually. A player must make his/her words so that no two letters or more are adjacent which, when read in the cross direction do not form a word or misspell a word. Word scores are determined by adding the value of the tiles comprising the word. Correctly spelled words generate a positive score, including bonus points, if applicable. Non-words and Incorrectly spelled words generate a negative scores. At the completion of a game, all the correct and incorrect words are automatically displayed with their individual word score values and a total game score.

A game is ended in one of two ways. First, the game is ended at the end of the five-minute play time limit, where upon the game word status is submitted for a final score. Otherwise, a game is ended by the election of a player, who has completed building his/her words, and who wants his/her results submitted for a final score.

A player can elect not to play the DAILY CHALLENGE, but instead elect to play a “random game”. A “random game” is played like the DAILY CHALLENGE, except each time a player enters a “random game”, a random generator generates a new set of 21 letter tiles and the three wild star tiles. Moreover, the score outcome from a “random game” is not posted to the “Top Scores”. A random game cannot be replayed.

A prize option competition is available. If a prize option is chosen, it is possible to announce a game competition time, so that everyone must play within the same designated five minute time period of a day, or a prize could be awarded to the top DAILY CHALLENGE score for the day.

A business can promote its trade names and/or products to be shown on various game screens. Marketing messages could be shown on the crossword grid where a game selection is made. Video advertisements can be shown and coupons could be distributed. Virtually any type of advertising could be created.

### BRIEF DESCRIPTION OF THE DRAWINGS

The features, advantages and operation of the present invention will become readily apparent and further understood from a reading of the following detailed description with the accompanying drawings, in which like numerals refer to like elements, and in which:

FIG. 1 shows the opening screen for the game where a player can play online against all challengers and on FACEBOOK against all challengers and a selected group of friend(s);

FIG. 2 shows the second screen requiring a player to sign in under a name when playing online;

FIG. 3 shows the player signed in;

FIG. 4 shows the next screen for a “play in English” link, a “play in Spanish” link, and a “check yesterday's top score” link;

FIG. 5 shows the pull-down choice to play the DAILY CHALLENGE or a “random (tile) game”;

FIG. 5a shows the display for the top score for the previous day;

FIG. 6 shows the overlay display when the letter distribution and point values link is selected;

FIG. 7 shows the overlay display when the “instruction” link is selected;

FIG. 8 shows the beginning of the DAILY CHALLENGE game;

FIG. 9 shows the countdown clock which starts with the play of a first tile;

FIG. 10 shows the play of a DAILY CHALLENGE game;

FIG. 11 shows the alphabet letter choice for a blue (3 point) wild star selection;

FIG. 12 shows the alphabet letter choice for a red (2 point) wild star selection;

FIG. 13 shows the alphabet letter choice for a yellow (1 point) wild star selection;

FIG. 14 shows the game “board” after the DAILY CHALLENGE game including wild star selections is concluded, where the player left two tiles un-played;

FIG. 15 shows a score display after the game of FIG. 14 is “submitted”;

FIG. 15a shows a printed “score report” (score card) for the game of FIG. 14, which is viewable and/or available for printout from the Internet to the player;

FIG. 16 shows the conclusion of the same DAILY CHALLENGE game with the same word selection as FIG. 14, but with different letter tile values in several positions;

FIG. 17 show a score display after the game of FIG. 16 is “submitted” showing a different score due to identical word building with different tile value positions for identical alphabet letters;

FIG. 17a shows a printed “score report” (score card) for the game of FIG. 16, which is viewable and/or available for printout from the Internet to the player;

FIG. 18 shows an alternate embodiment DAILY CHALLENGE before play with several board positions blacked out (blackened) as selected by the administrator, see FIG. 25, thereby prohibiting letter tile play for those positions;

FIG. 19 shows a DAILY CHALLENGE game played with the alternate embodiment of FIG. 18;

FIG. 20 shows the game score card including “what does the player now want to do” links;

FIG. 21 shows the display when the “challenge a friend” link is selected;

FIG. 22 shows an administrator display before the letters for a DAILY CHALLENGE are selected;

FIG. 23 shows the administrator display of FIG. 22 with 21 letters entered from a random number generator;

FIG. 24 shows the administrator display of FIG. 23 where the administrator has manually changed the letter distribution;

FIG. 25 shows the administrator display after the blackout button is selected in FIG. 24, and the administrator selects six arbitrary squares to blackout as shown for game play in FIGS. 18 and 19;

FIG. 26 shows the administrator display to upload the DAILY CHALLENGE data;

FIG. 27 shows the administrator display confirming the uploaded challenge data;

FIG. 28 shows a hardware implementation for the game;

FIG. 29 shows a block diagram flow chart for the implementation of the administrator program and the method of administration; and

FIGS. 30 and 31 show a block diagram flow chart for the implementation of the game and the method of play.

### DETAILED DESCRIPTION OF THE INVENTION

The present invention is a crossword game, which may be played manually or played in an electronic environment, such as a PC connected to the Internet, a tablet computer or a smart phone connected to a cell system, or an electronic station connected through a LAN to a local server.

The game is played on a square grid of 49 spaces with 21 pre-selected and assigned alphabet tiles and three wild star tiles for which an alphabet letter is selected by the player. Each alphabet tile (letter) is assigned a numeric value of from “1” to “3” (1, 2, 3,) and the three wild star tiles are always assigned the values “1”, “2”, or “3”, respectively. Each alphabet tile and each wild star tile is assigned a color according to value, with yellow being assigned for a “1” value, red being assigned for a “2” value, and blue being assigned for a “3” value.

For the DAILY CHALLENGE game for a given day, each play receives exactly the same 21 alphabet letter tiles, and of course the three wild star tiles. Each player, therefore, plays the same game with the exact same set of letter tiles. Each time a player plays the DAILY CHALLENGE on a given day, he/she receives the exact same set of letter tiles. Thus, a player can play against other players or play against himself/herself for a chance at a better score. High-point words, with a 10 to 12 word point count are assigned three additional bonus points. Higher-point words, with a word point count of 13 or greater receive five bonus points.

A player accumulates a score by building words from the assigned letters. As every player is provided the exact same letters with the exact same point count, in a DAILY CHALLENGE for the same day, there is a ‘level playing field”, with a chance-of-draw (luck of the draw factor) eliminated between players. Intersecting crosswords accrue points in both directions. Words are made left-to-right and top-to-bottom. Misspelled words (and/or non-words) each generate a point reduction. Words are checked against the Merriam Webster Collegiate Dictionary (Eleventh Edition).

### Crosswords Decisions and Rationales:

A grid of 49 squares (7 rows×7 rows) was chosen as most people don't have trouble making words of 7 letters or less, with most words made ranging from 2 to 5 letters. Twenty-four (24) tiles for game play, i.e., about 50% of spaces on the grid, was chosen as the number of tiles provided to a player. This number was arrived at after numerous testing trials, and it was discovered that all 24 of the tiles can generally be used most of the time. If not, a player usually has only 1 or 2 tiles left unused. Unused tiles evidence lost opportunity points, in addition to the additional points lost from other letter tiles they would be connected to in a word, if used. The 7-by-7 grid reasonably fits a computer screen display, when letter tile sizes of ½ inches on a side, i.e., 0.50 inches square are chosen. This size for the alphabet tiles and game board matrix is convenient for both young and old players. The number 7 is also considered a lucky number.

Most word games, like SCRABBLE, accord a higher point values to letters which are less often occurring, such as “Z”, “Q”, with a disproportionately higher letter point count, such as a point count of “10” for a “Z” and “0”. The other letters in SCRABBLE and similar games, have a large selection of point values ranging from “1” to “8”. In the present invention, all the letters can have all of three values (“1”, “2”, or “3”). Thus, no letter has a higher potential value than any other. The scoring system of the present invention allows a player to achieve high point word scores making use of every day, common words. Moreover, the point spread between player game scores is closer for novice and expert players than with other games. This departs from SCRABBLE type games, which reward players for making more difficult, and obscure types of words, in order to use higher point tiles to build higher word scores.

The present invention allows the same alphabet letter to be provided with varying values (“1”, “2”, or “3”), For example, the same letter can have a different value on different days, or if multiple copies of the same letter appear, they may have the same or different values.

An average player can get comparatively better results, i.e., a higher total point count, with the present invention than with other crossword games, where unusual words having seldom occurring letters or rarely used letters are rewarded with a higher point count. The lower tile point system devised in the present invention encourages the use of more common words, which in turn generates more satisfaction to an average player and encourages repeated play of the same DAILY CHALLENGE game of the day.

Players with a more extensive vocabulary, better spelling skills, and better strategic “critical thinking” skills may still get higher scores most of the time with present invention. However, the total scores will generally be closer. Critical thinking skills are a major part of the game, as the building of the exact same word with a different selection of letters will change the total point count. For example, making the word “deeper” with higher valued “E”s will result in a higher count for the word. Crossing “deeper” with the word “escape” at a higher value “E” will generate a higher word count for both words.

Bonus points are not earned by values assigned to the grid squares, as is played with SCRABBLE type games, where some of the grid squares may award double or triple letter bonuses and double or triple letter word scores. In SCRABBLE type games, the goal is to get at least a few extremely high scoring words each game, in order to be a top player. In these games, multiple players often use (play on) the same board, thereby vying against each other to occupy the higher and/or highest value grid squares, first, this becoming one of the goals (factors) of the SCRABBLE type games. These games are weighted toward using high point letters in high bonus situations.

In the DAILY CHALLENGE of the present invention, each player plays with the exact same set of tiles on an individual game board, where no grid blocks are assigned values for bonus points. The bonus points are achieved by making an individual word having a score of 10 to 12 points, for at least a four-letter word, or having an individual score of 13 or more points, for at least a five-letter word. The point system is important to earning bonus points. For example, a player can make the four-letter word “mark”. If that player makes the word “mark” with the letters “M”, “R” and ‘K” which add up to “8” points, and there is a “1” point letter “A” available and a “2” point letter “A” also available, the use of the “2” point letter will secure bonus points and the use of the “1” point letter will not. It may be wiser to use the “2” point “A”.

However, that will also depend upon the player's decision on the other words to be made from the remaining tiles provided. This type of decision may arise many times during the course of play of a game. It should be a player's goal to achieve/maximize bonus points in trying to maximize the overall game score.

Maximizing the points accumulated when crossing words is also major goal of the game. Each time a player makes a crossword, one of the letters is used in the crossing word and will be counted in each of the two words made, effectively doubling the value of the common tile that is used in both words. Thus, to gain the maximum total score it is best to try to cross the “3” point letter tiles first, the “2” point letter tiles next, and finally the “1” point letter tiles. The more successful players will strive to both maximize the crossword scores and achieve bonus points.

Most crossword games require a player to make words in a continuous crossword fashion. In the present invention, a player is encouraged to make continuous crosswords to maximize the score. However, a player can also make words both crossword style and individually, stand alone, or even several independent crosswords and/or stand alone words.

This provides for a greater opportunity for a player to use all of the 24 tiles, especially when, in an alternate embodiment, some of the grid squares are blacked out.

Letter tiles may be placed anywhere on the board at any time. They can also be moved during game play as much as the player may like to change, rearrange or create different words. The wild star tiles can also be placed anywhere on the board at any time. However, once a wild star tile is placed on a grid square and a letter is selected, the letter cannot be changed nor the tile moved to another grid square. It becomes locked in place.

“When, where, and how” best to use the wild star tiles is a major strategy decision of the game of the present invention. There is a “1”, “2”, and “3” point wild star tile included in each game, and any letter may be selected for each wild star tile.

The letter point values and bonus points result in total points scoring ranges of about 60 to 120 total points per game. This level of scoring has a sense of rationality to it. For example, most school work grading systems have a score of 90 to 100 as an “A”, 80 to 90 as a “B”, 70 to 80 as a “C”, below 70 as a “D”, and over 100, where bonus points are available, as an “A+”. The scoring philosophy of the present invention is similar.

The lower letter tile values of 1, 2 and 3 are also easier for players to add in their heads, when adding the total point values of individual words made while playing the game. Thus, the math is easier for younger and less skilled players.

The lower letter point values and bonus points also result in tighter competition with the present invention, thus encouraging interest and a desire to play. The highest daily scores will usually fall within a 5 point range of one another, thereby promoting more intense competition. Earning every last point is very important to being a daily “top scorer”.

A game score printout is provided which lists each of the words made, the individual word scores, the grid of letters played by position and value, and the total score. Any misspelled word deductions are also printed, as well as the grid with each of the letter tiles played including both correctly spelled and misspelled words. The player's name, date and time of play and the elapsed time of play are also provided. A database stores this data for publication on the Internet, for tracking and/or educational purposes, for competitions and bragging rights in “fantasy-type” game pools.

A play time of five minutes has been selected for each game. The clock does not start to count down until a first tile is played. Five minutes has been discovered as generally sufficient time for most players to complete a game. But it also keeps a game reasonably fast-paced. It creates pressure and a sense of urgency without being oppressive.

Allowing a player to replay the DAILY CHALLENGE in a particular day is important because a player can often improve play with subsequent plays of the same DAILY CHALLENGE. This leads to increased satisfaction and a personal sense of achievement.

Incorrectly spelled words result in having points subtracted from the final score, which discourages players from simply guessing at words. It also discourages players from spelling correct words in one direction to achieve a score while making incorrect crossing words in another direction without a penalty.

The numbering system of “1”, “2” and “3” imputes a subliminal message and possible marking slogan—“Easy to Play as 1, 2, 3”.

A record is kept in a given day of the five top scores. A full record of play as described above, is kept in a given day for the top score of the day. When a new top score is received, the record of play of the previous, eclipsed, top score is replaced by the record of play for the new top score. Once a game is ended, the score is dropped from the database, unless it is one of the five top scores.

### Administrator Control for Letter Selection and Blackout Squares:

Each day the administrator generates and selects for the DAILY CHALLENGE a group of 21 new letters through the administrator program, with the three wild star tiles being a constant. In this administration, the administrator first operates a random number generator which allows letters and the point values to be chosen randomly. The administrator may then manually adjust the letters and point values by deleting certain letters and then adding an equal amount of new letters, so the total number letter tiles remain at 21. The administrator may also manually change the point value that were also randomly generated to a different (1, 2, 3) point value.

With the letters being randomly selected, sometimes usual mixes of letters appear where it would be more difficult to use all the letters and get a higher score. Consequently, the administrator can make changes to the letter mix received from the random generator that makes it easier to form commonly occurring words. This easier mix will generally have 8 to 10 vowels and at most one or two “Z”s and “Q”s. Moreover, the administrator tries to keep the mix of letter values in the range of 50% “3” point tiles, and 25% each of “2” point and “1” point tiles regardless of what alphabet letters they are.

Generally, the letter and point value mixes do not vary greatly from the previously described allocation of vowels and point value distribution as it is easier to use all the letters and generally obtain higher scores with that allocation and point distribution. That being said, every once in a while a more difficult mix of letters and point values is presented, to make the game more challenging and unpredictable.

The game board which is a 49 square grid (7×7 squares), may sometimes be modified, wherein some of the squares may blacked out. Letter tiles may not be placed on the blackout squares. The blackout squares limit the length and placement of a word on that row or column. The administrator operates the administrative program to click on selected squares in the “blackout” mode, to create blackout squares button. Generally, no more than 5 to 8 of the squares on a 49 square grid are selected as blackout squares. The more squares that are blacked out, the more difficult and challenging the game becomes.

### Screen Presentations:

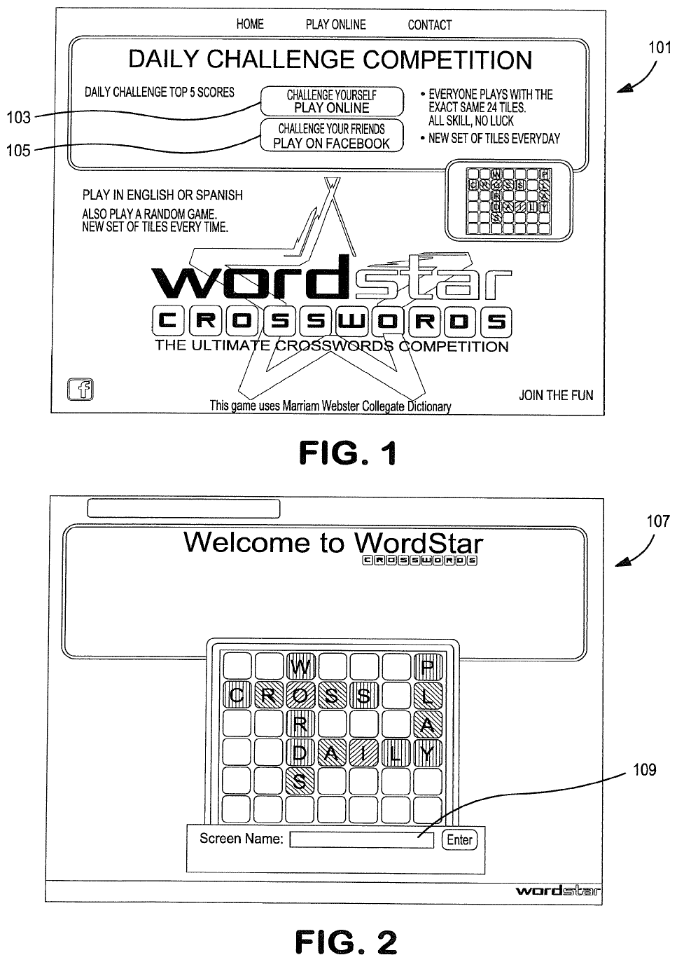

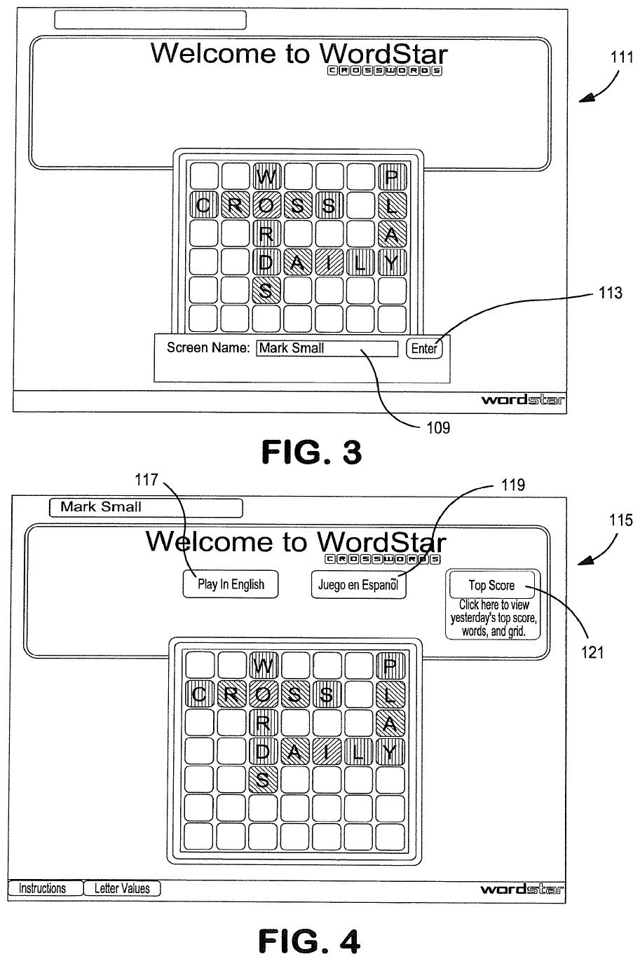

FIG. 1 shows the opening screen (home screen) 101 for the game where a player elects to play online 103 or to play on FACEBOOK 105 by clicking on the appropriate link 101 or 103. A second screen 107, FIG. 2, requires a player to sign in 109 on a sign-in “pad” 109 shown on the third screen 111, FIG. 3. This permits the game administrator program to store a player's play results and track play results in the system's database, and show the player's name on result printouts.

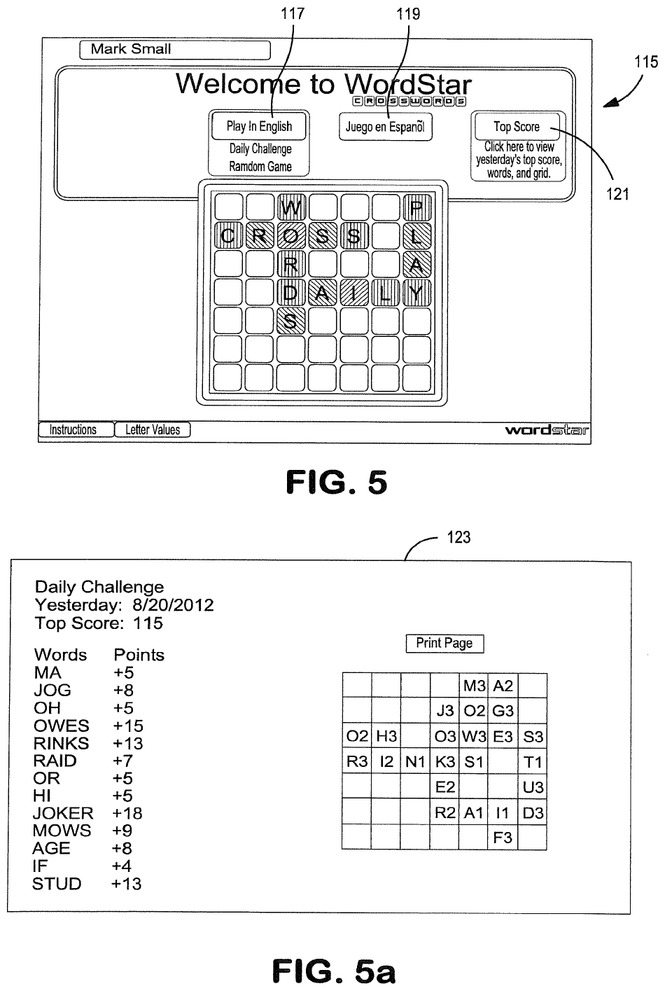

Having signed in on the pad 109, the player then clicks the enter button 113, FIG. 3, to bring up a fourth screen 115, FIG. 4, which displays “play-in-English” and “play-in-Spanish” buttons, 117, 119, respectively. The player's name is displayed at the top left corner of the fourth screen 115, and every play screen thereafter. The fourth screen 115 also displays a link button 121 to yesterday's top score. When the “play-in-English” button is touched with the mouse pointer, a drop-down screen appears, FIG. 5, giving the player a choice to click on, between playing the DAILY CHALLENGE or a “random” alphabet tile game. If the “top score” button is clicked, a report 123 of yesterday's top score from the DAILY CHALLENGE is displayed, FIG. 5a, showing the date, total score, words made and points awarded, and the layout of the crosswords on the 7-by-7 grid (game board). Yesterdays top score may be printed with date, total score, words made and points awarded.

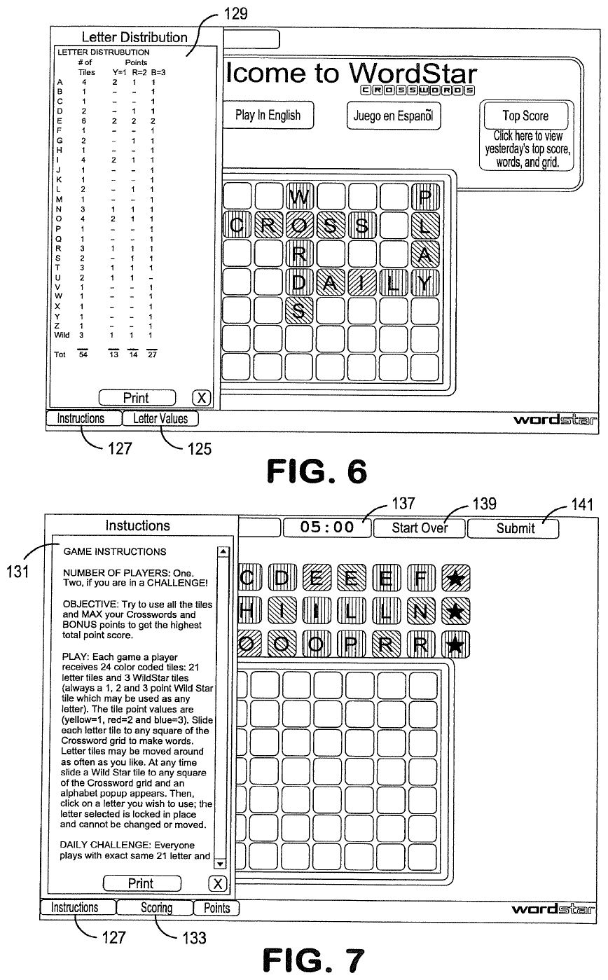

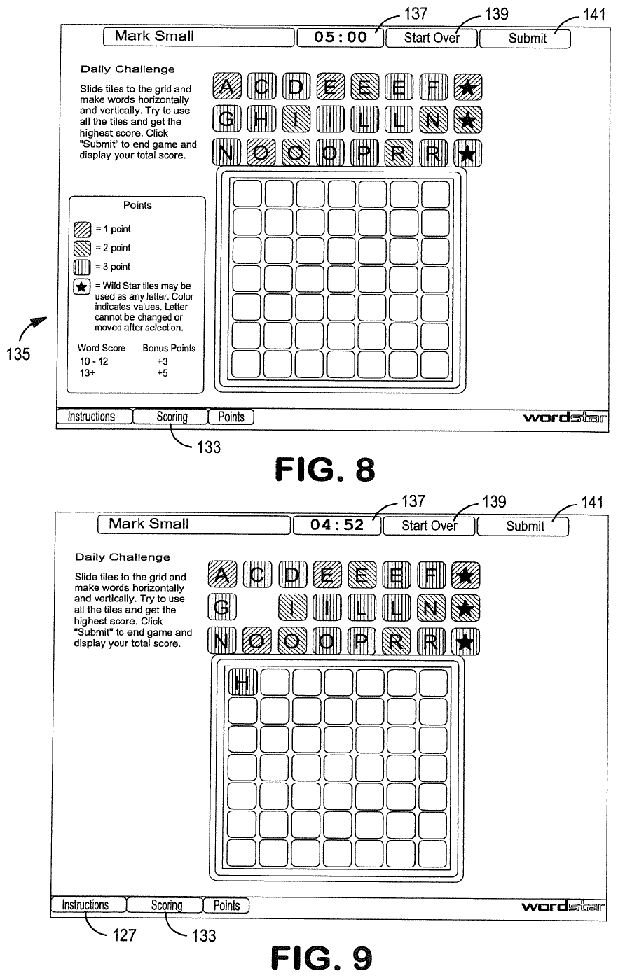

Prior to entering the play screen, a “letter values” button 125 and an instructions button 127 appear at the bottom left of the screen, FIGS. 6 and 7. If the letter values button 125 is clicked, a letter distribution overlay screen 129 appears, FIG. 6. If the instructions button 127 is clicked, an instructions overlay screen 131 appears, FIG. 7. If the “scoring” button 133, FIGS. 7 and 8, is clicked, a point scoring overlay screen 135 appears, FIG. 8. The instructions button 127 and the scoring button 133 are both available on a game play screen, FIGS. 7, 8 and 9.

The game play screen, FIGS. 7, 8, and 9, also shows a clock 137, a “start over” button 139, and a “submit” button 141. The clock 137 is originally set at 5:00 minutes, the time limit for both a DAILY CHALLENGE game and a random game, FIG. 8. The clock 137 does not start to count down until the first tile is played, FIG. 9.

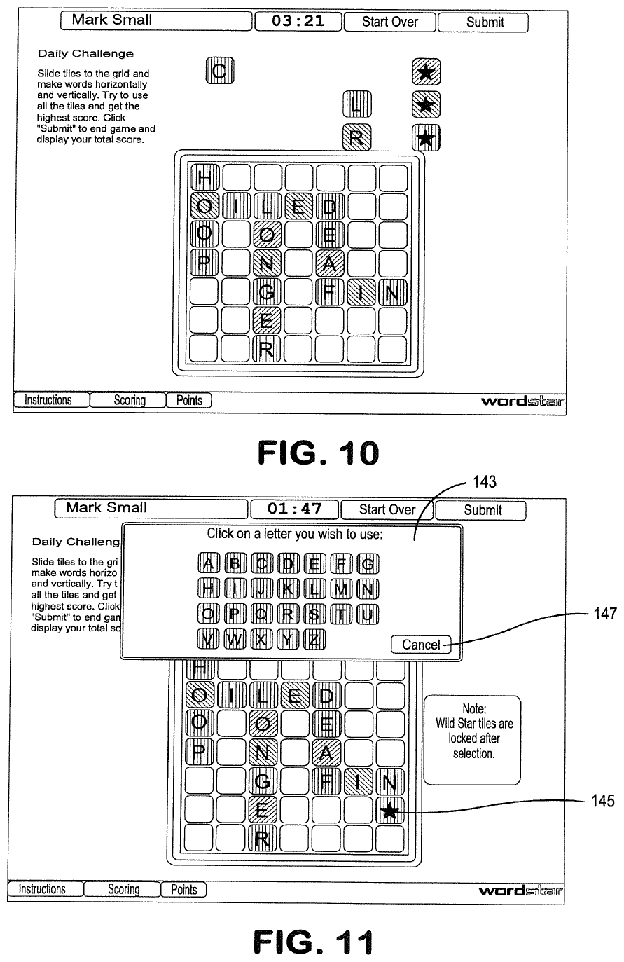

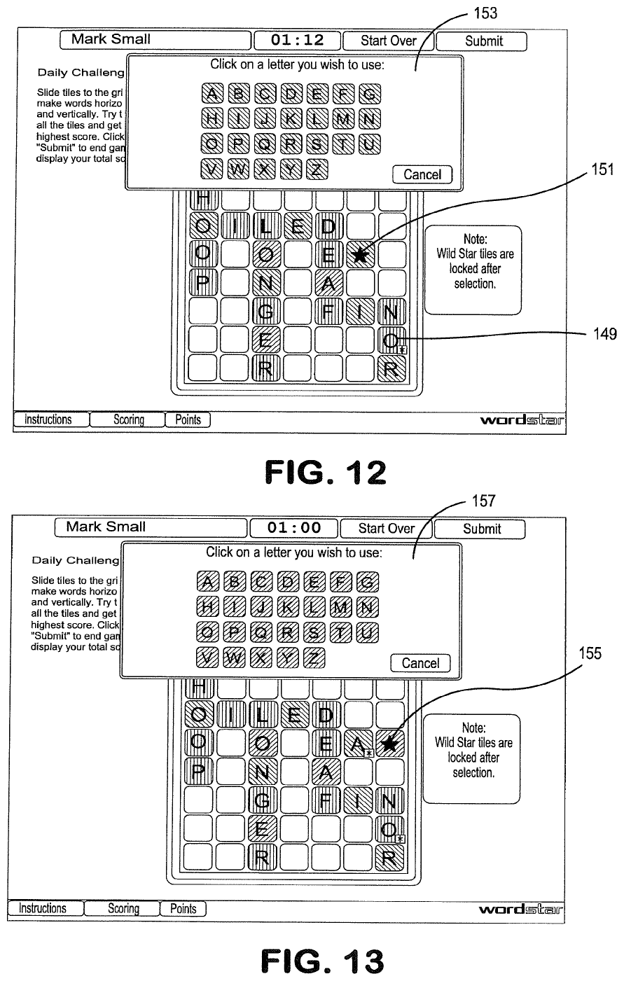

A player continues to build words during a game, FIG. 10. The tiles are color-coded, with a “3” point tile being “colored blue”, a “2” point tile being “colored red” and a “1’ point tile being “colored yellow”. When a blue (3 point) wild star tile is selected, FIG. 11, a “click-on letter” blue alphabet overlay display 143 appears and the player can select a blue (3 point) letter from the entire alphabet for the blue “star” 145 grid position chosen. The blue alphabet overlay 143 can be cancelled by clicking the cancel button 147. However, once a blue wild star replacement alphabet letter is chosen, its selection and grid position becomes permanent (fixed) and is marked by an asterisk symbol 149, FIG. 12.

This process is repeated, FIG. 12, for a red star 151 (2 point) grid position selection from the red alphabet overlay 153, shown in FIG. 12. This overlay can also be cancelled, and the alphabet letter selected and placed in a selected grid position becomes permanent. The process is likewise repeated, FIG. 13, for a yellow star 155 (1 point) grid position chosen, the yellow alphabet overlay display 157, and the alphabet letter selected 159.

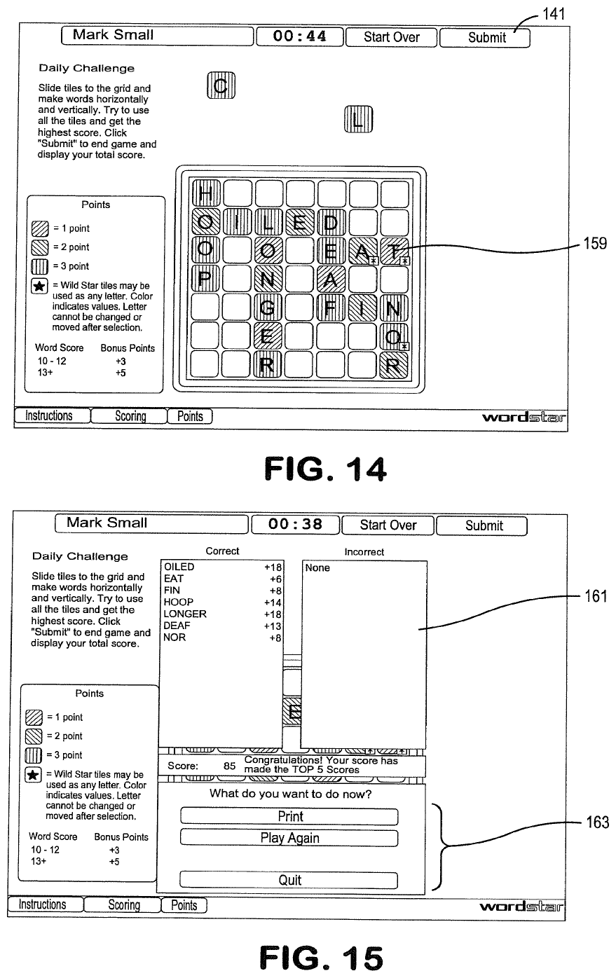

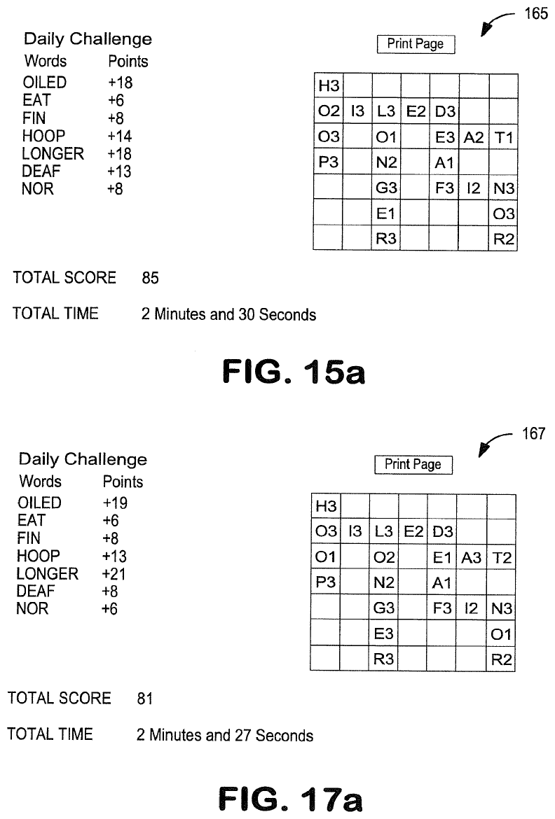

When a player decides he/she has finished a game, the “submit” button 141, FIG. 14 is clicked and the game is stopped. The player's scoring report is displayed in a score overlay display 161, FIG. 15. This display gives the player a choice of selecting “what to do now” 163, namely selecting between “print”, “play again” and “quit” tabs. Clicking the print tab produces a score display screen display similar to FIGS. 15a and 17a. After the player prints a game score, the player can return to the choice 163 screen FIG. 15 to push the quit tab which removes the player from the game system, or to push the play again tab which returns the player to the game selection screen, FIG. 4.

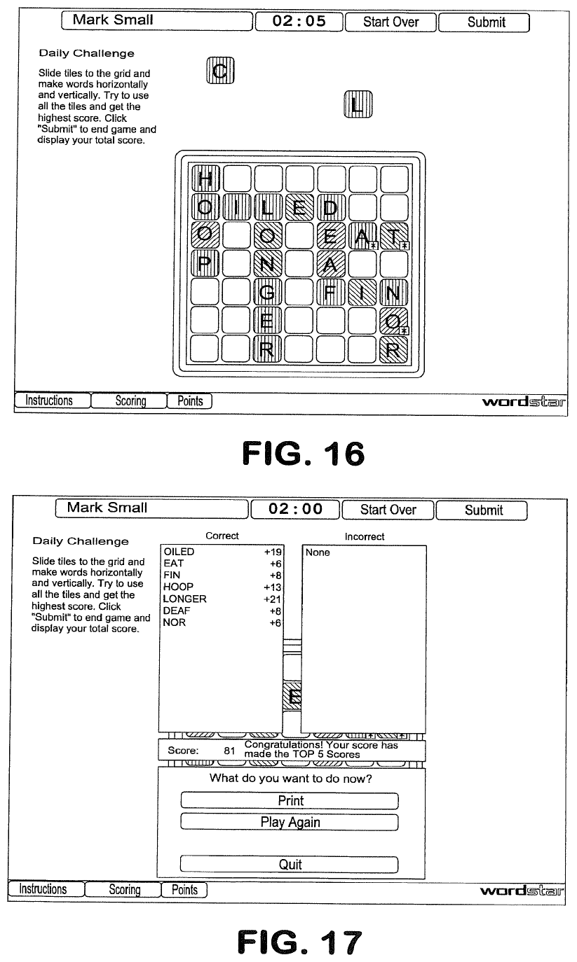

The same game can be replayed by a player making the same selection of words and cross words, but with different letter values in each word. Compare the game shown in FIG. 14 to the game shown FIG. 16, in which the player made the same words and cross words but selected different letter values for some of the letter positions. In this instance, a score of 85, as shown in FIG. 15, was achieved for the game results of FIG. 14, and a score of 81, as shown in FIG. 17, was achieved for the game results of FIG. 16, even though the exact same words and cross words were built. The score screen display 165 is shown in FIG. 15a for the game results displayed in FIGS. 14 and 15. The score screen display 167 is shown in FIG. 17a for the game results displayed in FIGS. 16 and 17.

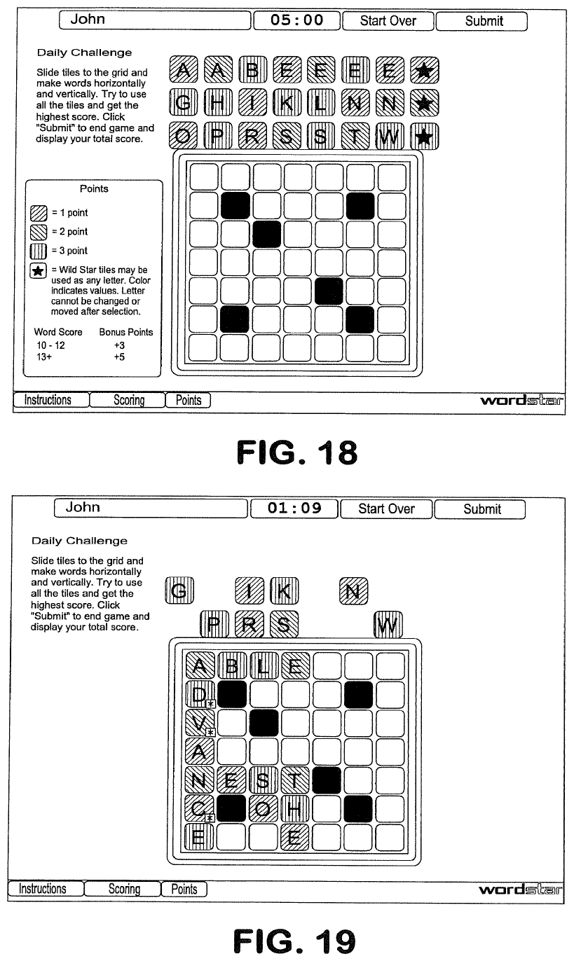

As an alternative grid, a grid with one or several grid blocks blacked out can be used, FIG. 18. The number and blacked out block pattern (location) position can be selected by the game administrator before a DAILY CHALLENGE is released, FIG. 25. The blacked out blocks limit the positioning of letters and/or words as shown in FIG. 19.

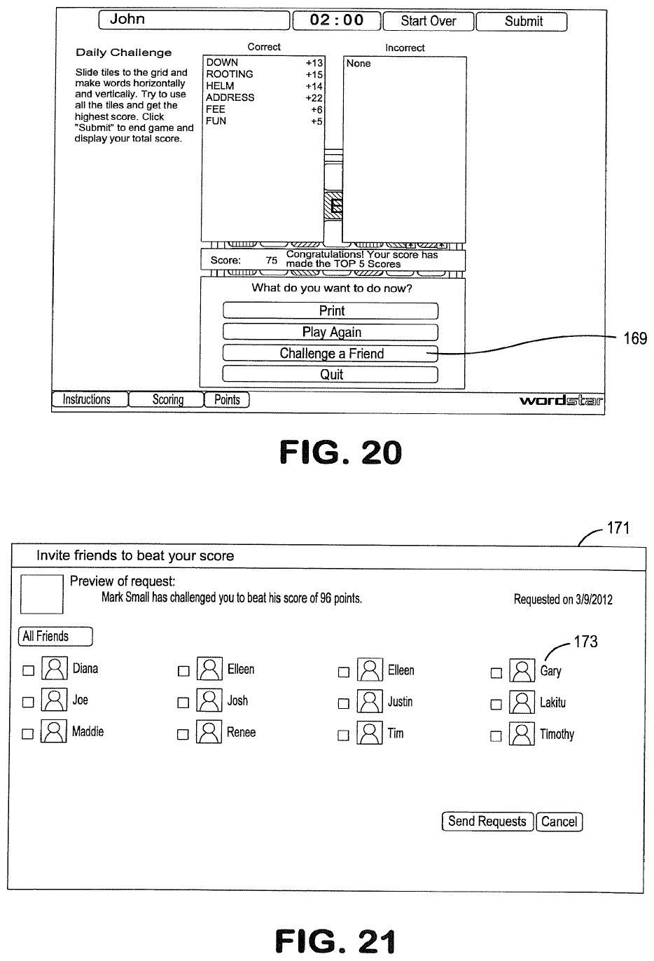

If a player has chosen to play on FACEBOOK, which is an election made on the opening screen 101, FIG. 1, then, when the submit button 141 is clicked, the “what do you want to do now” tabs 163, as shown previously on FIGS. 15 and 17, now include another selection tab, a FACEBOOK selection tab 169, FIG. 20. Clicking on this “Challenge a Friend Tab” 169 sends the player to his FACEBOOK account with a FACEBOOK display 171, FIG. 21, where the player can forward his/her DAILY CHALLENGE results to any and all of the FACEBOOK “friends” 173. Alternatively, a player can choose to enter the game directly from his/her FACEBOOK account.

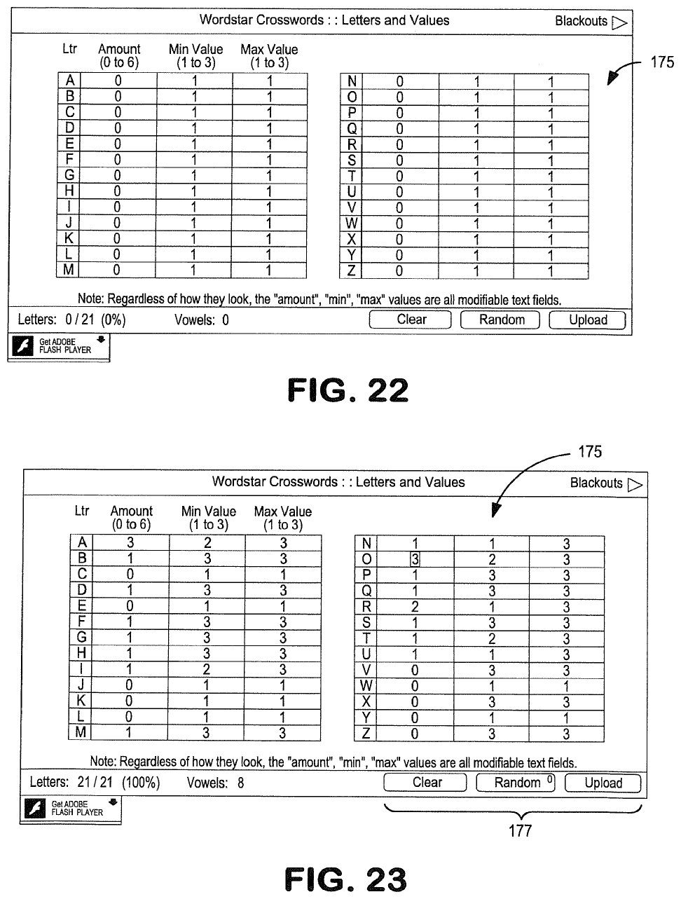

The administrator is the individual who loads (presents) and approves of the DAILY CHALLENGE tiles and grid each day. FIG. 22 shows the administrator display screen 175 which provides a table in which the number of tiles for each letter and the values can be shown. The table/screen 175 shows no letters selected, FIG. 22, before the DAILY CHALLENGE alphabet letter tiles are generated. At the bottom left margin the status of the table 175 is shown as, “Letters: 0/21 (0%) Vowels: 0”.

The administrator operates a random number generator to generate a selection of tiles, which appear on the administrator display screen 175, FIG. 23. The administrator is able to click control keys 177 at the bottom right of the screen to clear the values, re-operate the random generator or upload the approved letters to the DAILY CHALLENGE. Shown in FIG. 23 is a status summary: “Letters 21/21 (100%) Vowels 8”. The administrator can change, subtract, or add letters and letter values, by clicking on the table 175 column and row, as shown in FIG. 23.

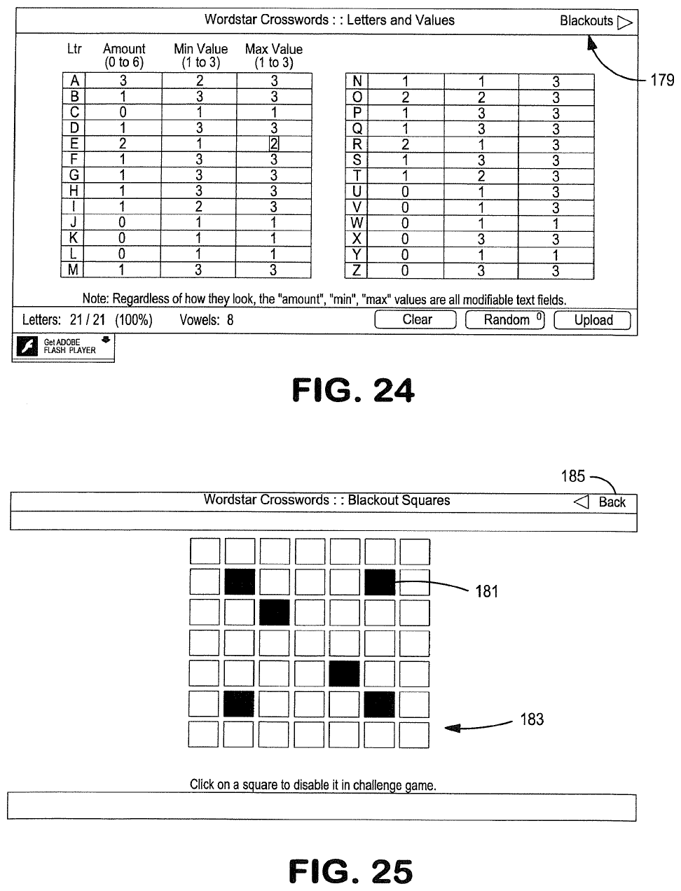

As shown in FIG. 24, the administrator has changed the DAILY CHALLENGE letter distribution from “3” letter “o”s, to “2” letter “o”s; and wants to change the value distribution to add “2” letter “e”s, FIG. 24.

The administrator also has the ability to add blackened squares or blocks to the grid. These shaded (blackened spaces) will prohibit the play of a letter on that grid square or block and limits the size of a word made in the column and the row in which the blackened block (square) appears. To enter this mode, the administrator clicks the blackout button 179, FIG. 24. This brings up a screen with empty grid blocks (squares). The administrator then clicks on a selection, being a number of grid blocks (squares) at a location selected by the administrator. The display, FIG. 25, then shows the selected blacked out blocks (blackened squares) 181 being darkened on the grid.

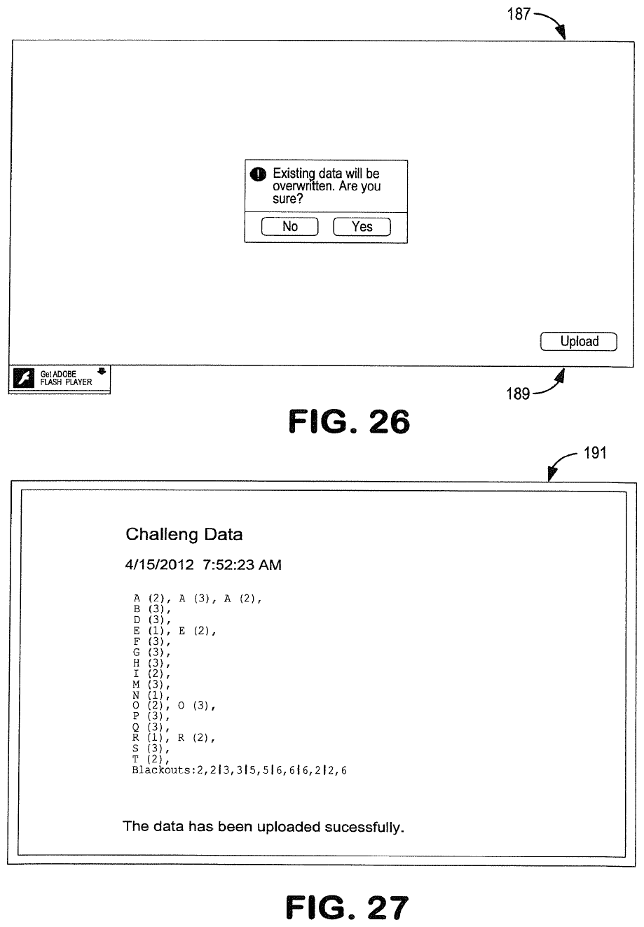

Once the administrator returns from the blackout selection grid 183, FIG. 25, by clicking on the “black” button 185, a decision screen 187, FIG. 26, appears asking the administrator if the chosen data is to be provided. If the administrator is satisfied, the upload button 189, FIG. 26, is clicked on and the DAILY CHALLENGE data for the day is presented on a challenge data screen 191. This screen 191, lists each letter and letter value and the blackout blocks (squares) for that day's DAILY CHALLENGE game.

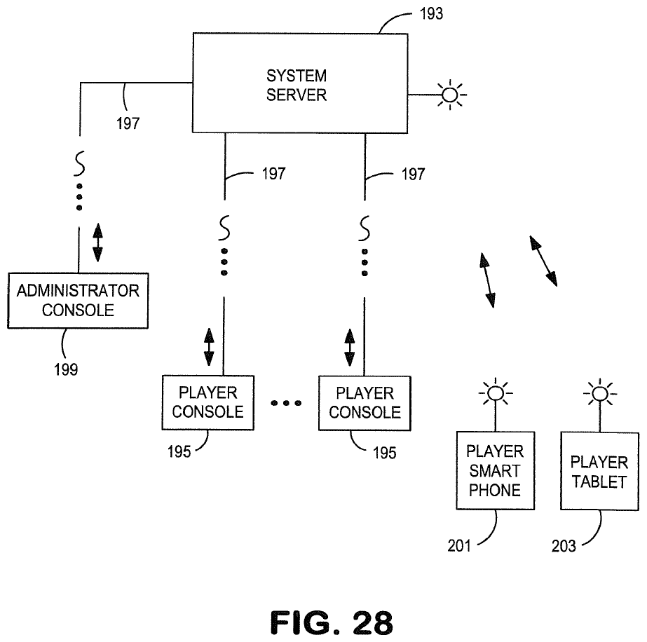

The game is implemented on a system server 193, which is connected to a plurality of player consoles 195, FIG. 28. The electrical or signal connection 197 with the server 193 may be by Ethernet wiring, by modem, by wireless (WiFi) connection or by other types of Internet connection depending upon the system in which the game is implemented. The server 193 can be located at an ISP location, or at a facility server location, or at the electronic control room of a school, arcade, casino, or other facility. An administrator console 199 is located at the administrator's location or a location convenient to the administrator's office or home. The signal connection 197 between the administrator's console 199 and the server, like the player connections, will depend upon the system setup and design.

Players may also play the game from a smart phone 201, or from a tablet PC 203. The player consoles 195 and the administrator console 199 may have custom circuitry and an imbedded CPU, or may be a desktop PC or a laptop with Internet capabilities.

The program which operates the game is written in Adobe FLASH and ASP (action script programming language). This application has ASP/ADO (action server pages/active data object) features. This application language is operational on MICROSOFT based equipment and other systems that function with FLASH. APPLE based equipment, such as an APPLE PC, or “iPad” or “iPhone” can operate in an environment where the application language is implemented in FLASH-free-FLASH. The administrator program is implemented in ASP regardless of whether a player's terminal is MICROSOFT or APPLE.

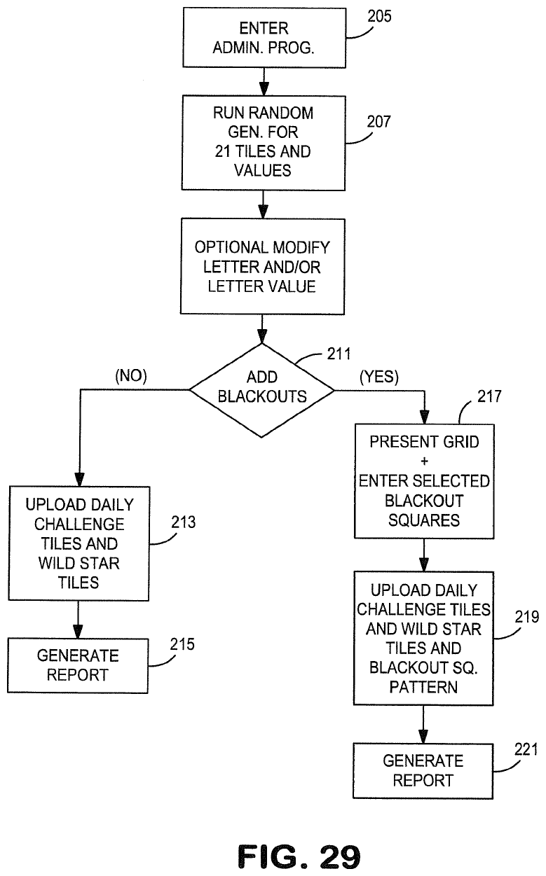

In the administrator program and method, the administrator enters the program 205, FIG. 29, and then runs the random generator for generating 21 DAILY CHALLENGE tiles and their values 207. An optional modification of letters generated and/or their values generated is performed 209. A decision to add blackouts (blackened blocks—squares) is quarried 211. If no blackouts are to be added, the current status of the DAILY CHALLENGE tiles and wild star tiles are uploaded 213 to the server, and a report is generated 215 to the administrator.

If blackouts are to be added, a grid with blacken squares selected is generated 217. Thereafter, the current status of the DAILY CHALLENGE tiles and wild star tiles and blackout square pattern is uploaded 219 to the server, and a report is generated 221 to the administrator.

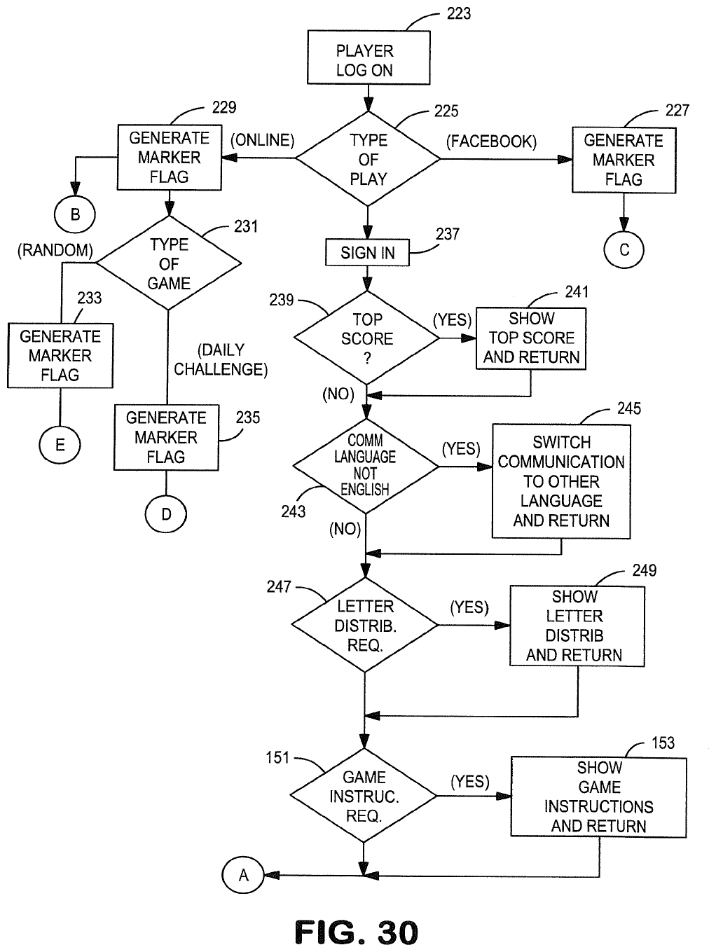

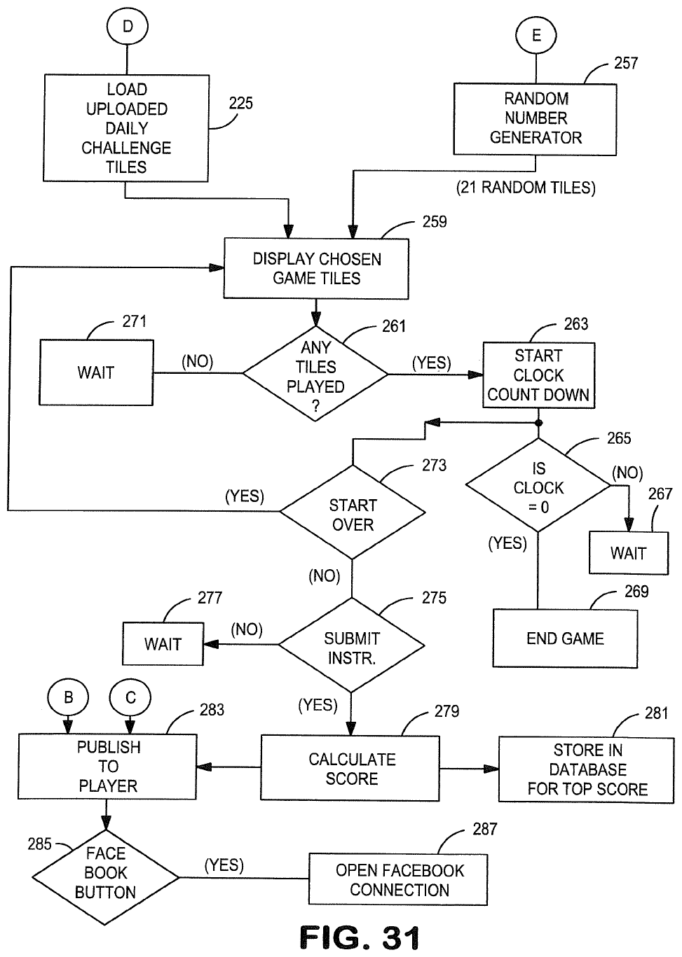

In the game play and method, a player first logs on 223, FIG. 30, and is queried as to the type of play desired 225. If FACEBOOK is selected a marker flag is generated 227. If play online is selected, a marker flag is generated 229, and the type of game is queried 231. If a “random” game is selected, a marker flag is generated 233. If the “DAILY CHALLENGE” game is selected, a marker flag is generated 235.

After the type of play query, the player is required to sign in 237, and has the opportunity 239 to elect to see the yesterday's top score and score report 241. After viewing the top score report, if elected, the player returns to the main path of the program and elects a language 243. If a foreign language is elected, the program switches all further communications with the player to that language 245 and then returns to the main program path. If there is no foreign language election, the program continues communicating in English.

The player then has the opportunity to elect a letter distribution overlay 247, in which a letter distribution listing is presented 249 until the player returns to the main program path. The player also has the opportunity to view the game instructions overlay 151, in which instance the game instructions are presented 153 until the player returns to the main program path.

If a DAILY CHALLENGE marker flag 235 has been set, the program loads the uploaded DAILY CHALLENGE tiles and wild star tiles 255. If a random tile flag 233 has been set, the program loads the uploaded random tiles generated from a random number generator 257. The game grid is then displayed with the respective game selected tiles 259.

The game clock is set and the program looks for the first tile played 261. When the first tile is played the clock starts to count down to zero 263. Until the clock reaches zero 265, this program controller waits 267. If the clock reaches zero the game is automatically ended 269. On the other hand, if no tiles are played the controller waits 271.

Once the program determines that a first tile has been played, it returns to the main program path, which permits a player to start over 273. If the player elects to play on, the controller looks for the player to submit an instruction 275. Until the player submits an instruction the controller waits 277. If a submit instruction is sent 275, the program calculates the game score 279 and stores the game score, letter distribution, date and player's name in a database for top scores 281, which results in a top score congratulations announcement to the player if the score is in the top score range.

In addition, the game results are published to the player 283 only if an online play selection marker 229 is present. However, if a FACEBOOK play selection marker 227 is present, the player is asked to click the FACEBOOK button 285, i.e., the “Challenge a Friend Tab” 169. When that occurs, the FACEBOOK connection is opened 287 and the player can publish the game results to selected friends. On FACEBOOK, a player has the option to post their to score results on his/her FACEBOOK wall.

The purpose of the DAILY CHALLENGE game is to promote game play competition based solely on skill without the luck of the draw factor. Plural DAILY CHALLENGE tiles may be provided for the same alphabet letter with the same or a different point count. The three individual wild star tiles, with the point value distribution of a “1”, a “2” and a “3”, may each be individually exchanged, at any time, for any alphabet letter which then assumes the point value of the exchanged wild star tile. Tile point values are selected between 1 and 3 to keep a particular DAILY CHALLENGE game outcome reasonably close to other DAILY CHALLENGE game outcomes for the same day, to promote game replaying by a player who desires to achieve a higher score, and to keep scoring simple.

Many changes can be made in the above-described invention without departing from the intent and scope thereof. It is therefore intended that the above description be read in the illustrative sense and not in the limiting sense. Substitutions and changes can be made while still being within the scope and intent of the invention and of the appended claims.

1. A crossword game system, playable by multiple players, individually, comprising:
a set of alphabet letter tiles, said tiles each being assigned a number value between one and three (1, 2, 3);
a set of three wild tiles, each being assigned a number value between one and three, on an exclusive basis;
wherein each wild tile is interchangeable with an additional alphabet letter tile of the player's selection, said interchanged alphabet letter tile being assigned the same number value as said wild interchanged tile;
wherein said set of alphabet letter tiles can have plural tiles of the same alphabet letter and the same or different number values;
a grid board for making words and crosswords with said tiles;
wherein each player has an individual dedicated grid board;
wherein each player is provided with the same identical set of alphabet letter tiles and three wild tiles with the same identical set of corresponding point values, said set of alphabet letter tiles remaining unchanged once a game is started and until said game is completed; and
wherein each player's total score is counted after the player has completed the game, as a function of word values being cumulative of individual tile values and any bonus points and any deductions, for comparison of that player's total score with one or more other players' scores.

2. The game system of claim 1, wherein each player can elect to replay a game with said identical set of alphabet letter tiles and three wild tiles with the same respective point values as before for trying for a higher score.

3. The game system of claim 2, wherein game play is regulated by a game clock.

4. The game system of claim 3, wherein the game clock counts five minutes, and wherein if the player does not complete the game before the five minutes, the game is automatically ended.

5. The game system of claim 4, wherein bonus points are awarded for words of higher score.

6. The game system of claim 5, wherein said grid board is 7-by-7 blocks (squares) in seven columns and seven rows, each of which being capable of accepting a tile.

7. The game system of claim 6, wherein the set of alphabet letter tiles has 21 letter tiles, and wherein the three wild tiles are each interchangeable with any one of the 26 alphabet letters.

8. The game system of claim 7, wherein words are made by placing tiles on a set of grid blocks, from left to right or from top to bottom, either by stand-alone words or crosswords sharing a common letter.

9. The game system of claim 8, wherein any alphabet letter tile from the set of 21 tiles may be moved to a different block location at any time, and wherein a particular alphabet letter tile of particular value, may be interchanged with the same alphabet letter tile of a different value.

10. The game system of claim 9, wherein once a wild tile is interchanged for an alphabet letter tile, and that interchanged tile has been placed on a particular grid block, said alphabet letter tile selected for said wild tile cannot be changed and said wild tile cannot be moved.

11.-30. (canceled)
